(19) United States
(12) Patent Application Publication
(10) Pub. No.: US 2006/0054182 A1
(43) Pub. Date: Mar. 16, 2006

(54) System and method of powering a sonic energy source and use of the same to process substrates

(76) Inventors: John Korbler, Mertztown, PA (US); Ismail Kashkoush, Orefield, PA (US); John Volkert, New Tripoli, PA (US); Michael Peters, Tucson, AZ (US); Pejman Fani, San Diego, CA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/227,705

(22) Filed: Sep. 15, 2005

Related U.S. Application Data
(60) Provisional application No. 60/610,633, filed on Sep. 15, 2004.

(51) Int. Cl. B08B 3/12

(52) U.S. Cl. 134/1

(57) ABSTRACT

A system and method of supplying power to a sonic energy source that minimizes damage to substrate devices during processing while increasing processing efficiency and/or effectiveness. The system and method utilize the concept of ramping the amplitude and/or varying the frequency of the electrical signal used to drive the sonic energy source, thereby resulting in corresponding ramping and/or variations in the amplitude and frequency of the resulting sonic energy being applied to the substrate. A method of processing a substrate with sonic energy comprising: a) supporting at least one substrate in a process chamber; b) generating a base electrical signal; c) transmitting the base electrical signal to an amplifier, the amplifier converting the base electrical signal into an output electrical signal having a peak amplitude; d) transmitting the output electrical signal to a transducer, the transducer converting the output electrical signal into corresponding sonic energy; e) applying the sonic energy to the at least on substrate supported in the process chamber; and f) ramping the peak amplitude of the output electrical signal.

### CROSS-REFERENCE TO RELATED PATENT APPLICATIONS

The present application claims the benefit of U.S. Provisional Patent Application 60/610,633, filed Sep. 15, 2004, the entirety of which is hereby incorporated by reference herein.

### FIELD OF THE INVENTION

The present invention relates generally to systems and methods for processing substrates using acoustical energy, and specifically to systems and methods of controlling acoustical energy sources that are used in semiconductor wafer processing. The invention, however, can be applied to the manufacture of raw wafers, lead frames, medical devices, disks and heads, flat panel displays, microelectronic masks, and other devices that require high cleanliness.

### BACKGROUND OF THE INVENTION

In the field of semiconductor manufacturing, it has been recognized since the beginning of the industry that removing particles from semiconductor wafers during the manufacturing process is a critical requirement to producing quality profitable wafers. While many different systems and methods have been developed over the years to remove particles from semiconductor wafers, many of these systems and methods are undesirable because they cause damage to the wafers. Thus, the removal of particles from wafers must be balanced against the amount of damage caused to the wafers by the cleaning method and/or system. It is therefore desirable for a cleaning method or system to be able to break particles free from the delicate semiconductor wafer without resulting in damage to the device structure.

Existing techniques for freeing the particles from the surface of a semiconductor wafer utilize a combination of chemical and mechanical processes. One typical cleaning chemistry used in the art is standard clean 1 (“SC1”), which is a mixture of ammonium hydroxide, hydrogen peroxide, and water. SC1 oxidizes and etches the surface of the wafer. This etching process, known as undercutting, reduces the physical contact area to which the particle binds to the surface, thus facilitating ease of removal. However, a mechanical process is still required to actually remove the particle from the wafer surface.

For larger particles and for larger devices, scrubbers have been used to physically brush the particle off the surface of the wafer. However, as device sizes shrank in size, scrubbers and other forms of physical cleaners became inadequate because their physical contact with the wafers was causing catastrophic damage to smaller devices.

Recently, the application of acoustical/sonic energy to the wafers during chemical processing has replaced physical scrubbing to effectuate particle removal. The sonic energy used in substrate processing is generated via a source of sonic energy. Typically, this source of sonic energy comprises a transducer which is made of piezoelectric crystal. In operation, the transducer is coupled to a power source (i.e. a source of electrical energy). An electrical energy signal (i.e. electricity) is supplied to the transducer. The transducer converts this electrical energy signal into vibrational mechanical energy (i.e. sonic energy) which is then transmitted to the substrate(s) being processed. Characteristics of the electrical energy signal supplied to the transducer from the power source dictate the characteristics of the sonic energy generated by the transducer. For example, increasing the frequency and/or amplitude of the electrical energy signal will increase the frequency and/or amplitude of the sonic energy being generated by the transducer.

Moreover, the relationship between sonic energy frequency and particle size removal has become known. In essence, higher frequencies are more effective at removing smaller-sized particles while lower frequencies are effective at removing larger-sized particles. Today, typical sonic energies delivered during cleaning processes range from 500 kHz to slightly over I MHz. Megasonic energy has proven to be a effective way to remove particles, but as with any mechanical process, damage is possible and megasonics are faced with the same damage issues as traditional physical cleaning methods and apparatus.

To improve cleaning and to reduce damage caused to wafers by the application of megasonic energy, megasonic suppliers have implemented solutions that control the frequency of the sonic energy, the amplitude of the sonic energy, and the angles at which the sonic energy is applied to the wafers. However, even with these controls, damage is still occurring.

Referring to FIG. 1, a prior art megasonic power control system 100 is schematically illustrated. Prior art megasonic power control system 100 consists of a frequency generator 10, a power control 20 having analog signal control capabilities, an amplifier 30, a transducer 40, and a system controller 50. Frequency generator 10 and power control 20 are operably coupled to amplifier 30. System controller 50 is operably coupled to power control 20 to facilitate control and communication therewith. Prior art system 100 affords only analog level control of the amplitude of the electrical signal being supplied to the transducer 40.

In operation of prior art system 100, frequency generator 10 generates and transmits a base signal 15 to the amplifier 30 that dictates the frequency of the electrical signal 35 outputted/created by the amplifier 30. The outputted electrical signal 35 has a constant frequency. The amplifier 30 is also controlled by power control 20 which dictates the amplitude of the electrical signal 35 via an amplitude control signal 25. System controller 50, through proper programming, controls power control 20 so that amplifier 30 outputs the electrical signal 35 at a desired constant peak amplitude. The outputted electrical signal 35 is transmitted to transducer 40. The outputted electrical signal 35 has a constant frequency and a constant peak amplitude.

Outputted electrical signal 35 is received by the transducer 40 and converted into sonic energy 45 having a constant frequency and a constant peak amplitude that corresponds to the constant frequency and the constant peak amplitude of the electrical signal 35. The sonic energy 45 created by the transducer 40 is then transmitted to a substrate or other article to facilitate processing (not shown).

When prior art system 100 is used to initially create sonic energy during a start-up procedure, the amplifier 30 goes from producing no signal (i.e., a signal with zero amplitude) to immediately producing an electric signal 35 having a predetermined constant peak amplitude in a step-like function. In other words, the amplifier 30 simply has two states “off” and “on.” This can result in the front end of the electrical signal 35 having an undesirable spike in its amplitude, which in turn, results in an undesirable spike in the amplitude of the sonic energy 45 being delivered to a substrate. This spike can cause damage to devices on the substrate.

Similar problems exist if the peak amplitude of the electrical signal 35 is varied (i.e., increased or decreased) during processing. For example, if the amplitude of the electrical signal 35 is increased from 40 Watts to 100 Watts, the amplifier 30 jumps the amplitude of the electrical signal 35 in a one-step function from 40 Watts to 100 Watts. Such jumps in amplitude can produce undesirable power spikes that can catastrophically damage devices on the substrates being processed.

Another drawback of prior art megasonic power control system 100 is its inability to vary the frequency of the outputted electrical signal 35.

### SUMMARY OF THE INVENTION

It is therefore an object of the present invention is to provide a system and method of supplying power to a sonic energy source that reduces and/or eliminates the damage caused to substrates from the sonic energy generated.

Another object of the present invention is to provide a system and method of supplying power to a sonic energy source that reduces and/or eliminates spikes in the amplitude of the sonic energy generated.

Yet another object of the present invention to provide a system and method of supplying power to a sonic energy source that increases particle removal from substrates.

A further object of the present invention is to provide a system and method of supplying power to a sonic energy source that can adjust the frequency and/or amplitude of the sonic energy being generated during particle removal processes.

A still further object of the present invention is to provide a system and method of supplying power to a sonic energy source that increases the device yield of substrates subjected to the generated sonic energy.

A yet further object is to provide a system and method of supplying power to a sonic energy source that provides a scrubbing action to substrates subjected to the generated sonic energy.

Another object of the present invention is to provide a system and method of supplying power to a sonic energy source that provides improved control over a process chemistry's concentration of gas.

Still another object of the present invention is to provide a system and method of supplying power to a sonic energy source that produces a tight bandwidth of sweeping frequency which minimizes nodeing of the megasonic energy generated.

A further object is to provide a system and method of processing substrates that improves processing efficiency and/or particle removal.

These and other objects are met by the present invention. The present invention utilizes the concept that the characteristics of the sonic energy generated by transducers (and subsequently applied to the substrates) can be controlled by controlling the corresponding characteristics of the electrical signal (i.e. power signal) driving the transducers. Importantly, these characteristics include frequency and/or amplitude. By utilizing this concept, the system and method of the present invention provides an additional layer of control for the supply of electrical signals to the transducers. The invention allows users to control the frequency and/or amplitude of the power delivered to the transducer crystals and, in turn, effectively to the substrate.

According to one embodiment of the invention, instead of providing only analog level control of the power being supplied to the transducers, the system and method affords active control of the amplitude and/or frequency of the sonic energy being generated by the transducers.

In one aspect, the invention is a method of processing a substrate with sonic energy comprising: a) supporting at least one substrate in a process chamber; b) generating a base electrical signal; c) transmitting the base electrical signal to an amplifier, the amplifier converting the base electrical signal into an output electrical signal having a peak amplitude; d) transmitting the output electrical signal to a transducer, the transducer converting the output electrical signal into corresponding sonic energy; e) applying the sonic energy to the at least on substrate supported in the process chamber; and f) ramping the peak amplitude of the output electrical signal.

Because it has been discovered that at least some of the damage caused to substrates (e.g., semiconductor wafers) during megasonic processing, such as cleaning, is due to the sonic energy experiencing amplitude spikes. As discussed briefly above, these spikes have been discovered to typically occur during the startup of the sonic transducers and/or from reflective standing waves causing both nodes and anti-nodes in the power due to the sonic reflection in the chemical tanks. Thus, in one embodiment of the invention, the ramping of the peak amplitude of the output electrical signal will be performed during the start-up of the transducers for substrate processing. In this embodiment, the ramping can comprise increasing the peak amplitude of the output electrical signal from a substantially zero value to an operating value. The exact time it takes to ramp the output electrical signal from the substantially zero value to the operating value depends the desired power at which the substrates are to be processed and the style of transducer/transmitter used in the megasonic cleaning system.

The ramping of the electrical signal during start-up results in a gradual activation of the transducer during substrate processing, thereby eliminating amplitude spikes in the sonic energy applied to the substrates. In other words, by controlling the leading edge of the electrical signal being supplied to the transducer, it is possible to control the startup characteristics of the megasonics transducer, thus eliminating the initial power spikes that have been discovered to be common with power on transition.

When used during substrate processing, the ramping can be used to perform a “sonic scrubbing” action. In this embodiment, the ramping step will comprise repetitively increasing and decreasing the peak amplitude of the output electrical signal in a cyclical manner within a predetermined range. This results in the amplitude of the sonic energy being applied to the substrate by the transducers to also repetitively increase and decrease in a corresponding manner. The sonic scrubbing action created by the sonic energy improves the particle removal efficiency while minimizing damage to the delicate devices on the substrate. Additional capabilities include: (1) quickly boosting the amplitude of the sonic energy during substrate cleaning for high power short bursts of energy; (2) mild to low amplitude cleans; and (3) low amplitude degasification phase to provide improved control over a chemistry's concentration of gas.

Preferably, the predetermined range within in which the output electrical signal is ramped during the “sonic scrubbing” technique is between an operating value of the output electrical signal and a percentage of the operating value that is less than 100%. More preferably, the percentage is greater than or equal to about 10% and less than 100%. By maintaining the range of the output electrical signal at or below the operating value at all times during the “sonic scrubbing,” the substrates are not subjected to excessive sonic energy power levels that may damage delicate devices.

Most preferably, the ramping during “sonic scrubbing” comprises repetitively increasing and decreasing the peak amplitude of the output electrical signal in a cyclical manner between a de-minimus value and an operating value. By just avoiding total shut- off of the electrical signal, undesirable effects, such as system instability, are avoided while allowing the largest range in which the amplitude can be ramped. Driving small amounts of power into the piezoelectric crystal defines the impedance of the piezoelectric crystal the amplifier must drive, thus providing a stable system that can have faster ramping rates. The de-minimus value can be, for example, less than 1% of the operating value. The exact wattage of the de-minimus value will ultimately depend on the characteristics of the hardware used and the power needed to drive it.

Irrespective of whether the ramping of the peak amplitude of the output electrical signal takes as a start-up control or as a “sonic scrub,” the ramping is not a step function. The ramping of the peak amplitude can take on a linear, parabolic, or S-profile function. The invention however, is not limited to any ramping profile. The ramping of the peak amplitude of the electrical signal can be achieved in a variety of ways, including without limitation: (1) transmitting a previously ramped base electrical signal to the amplifier; and (2) ramping the output electrical signal through control of the amplifier itself during the conversion of step f).

In one embodiment, an analog waveform generator can be operably coupled to the amplifier for effectuating the conversion of the base electrical signal to the output electrical signal. Most preferably, the sonic energy is in the megasonic range.

The invention also utilizes the fact that varying the frequency of the electrical signal driving the transducers results in corresponding variance of the sonic energy being generated and applied to the substrates. This is especially beneficial in cleaning processes because it has been discovered that varying the frequency of the sonic energy results in the more effective removal of particles having multiple size. Referring to the fact that low frequencies are effective at cleaning large particles, and higher frequencies are effective at removing smaller particles, the frequency variation aspect of the present invention enables a single cleaning module to be effective across a larger range of particle sizes. Frequency control can also be extended to frequency modulation according to an embodiment of the present invention, where the system provides control over the generator to produce a tight bandwidth of sweeping frequency which minimizes nodeing of the sonic energy. The advantage of this capability is reduction of peak power delivery and thus lower damage possibilities.

The frequency variation techniques can be used either alone or in combination with the amplitude ramping technique discussed above. When used in combination with amplitude ramping, the method of the present invention discussed above will further comprise varying the frequency of the output electrical signal during the application of the sonic energy to the substrate.

The frequency of the output electrical signal can be varied in such a manner to achieve a variety processing techniques, including “frequency sweeping” and/or “frequency jumping.” When utilizing the “frequency sweeping” technique, the frequency varying step of the invention further comprises repetitively increasing and/or decreasing the frequency of the output electrical signal within the predetermined range. This predetermined range is preferably within +/−10% of a primary operating frequency of the transducer (when the transducer comprises a piezoelectric crystal). Most preferably the predetermined range is within +/−1% of a primary operating frequency of the transducer.

When utilizing the “frequency jumping” technique, the frequency varying step of the invention further comprises changing the frequency of the output electrical signal from a primary operating frequency of the transducer to at least one secondary operating frequency of the transducer.

Varying the frequency of the output electrical signal is preferably accomplished by varying the frequency of the base electrical signal during generation, through the use of a variable frequency generator or the like.

As mention above, the technique of frequency variation can be used independent of amplitude ramping. When so used, the invention can be, in another aspect, a method of processing a substrate with sonic energy comprising: a) supporting at least on substrate within a process chamber; b) generating an electrical signal having a frequency; c) transmitting the electrical signal to a sonic energy source; d) the sonic energy source converting the electrical signal to sonic energy having a frequency corresponding to the frequency of the electrical signal; e) applying the sonic energy to a surface of the substrate; and f) varying the frequency of the electrical signal while the electrical signal, thereby correspondingly varying the frequency of the sonic energy being applied to the substrate.

Preferably, the frequency of the electrical signal is varied within a predetermined range that results in the sonic energy being generated over a range of frequency targeted to assist in removal of various sized particles from a substrate being subjected to the sonic energy.

Any embodiment of the invention can be incorporated into a cleaning process or system. In such an embodiment, the inventive methods may further comprise: applying a film of cleaning fluid to a surface of the substrate supported in the process chamber, the substrate supported in a substantially horizontal orientation; wherein the transducer is operably coupled to a transmitter, the transmitter coupled to the film of cleaning fluid; and wherein the transmitter transmits the sonic energy through the film of cleaning fluid and to the surface of the substrate.

In yet another aspect, the invention is a method of supplying power to a sonic energy source comprising: a) generating a base electrical signal; b) transmitting the base electrical signal to an amplifier; c) the amplifier converting the base electrical signal into an output electrical signal having a peak amplitude; d) transmitting the output electrical signal to a sonic energy source; e) the sonic energy source converting the output electrical signal into corresponding sonic energy; and t) ramping the peak amplitude of the output electrical signal.

In still another aspect, the invention is a system for supplying power to a transducer for generating sonic energy comprising: an electrical signal generator; an amplifier operably coupled to the electrical signal generator, the amplifier adapted to receive an electrical signal generated by the electrical signal generator and convert the electrical signal into an output electrical signal having a peak amplitude; a power control operably coupled to the amplifier, the power control adapted to ramp the peak amplitude of the output electrical signal; and at least one transducer operably coupled to the amplifier, the transducer adapted to receive the output electrical signal from the amplifier and convert the output electrical signal to corresponding sonic energy.

In a further aspect, the invention can be a system for processing at least one substrate comprising: a process chamber having a support for supporting at least one substrate; means for generating sonic energy having a peak amplitude to a substrate positioned on the support; means for ramping the peak amplitude of the sonic energy created by the generation means; and a system controller adapted to control the means for applying sonic energy.

In a still further aspect, the invention is a system for supplying power to a transducer for generating sonic energy comprising: an electrical signal generator; an amplifier operably coupled to the electrical signal generator, the amplifier adapted to receive an electrical signal generated by the electrical signal generator and convert the electrical signal into an output electrical signal having a peak amplitude; a power control operably coupled to the amplifier, the power control adapted to ramp the peak amplitude of the output electrical signal; and at least one transducer operably coupled to the amplifier, the transducer adapted to receive the output electrical signal from the amplifier and convert the output electrical signal to corresponding sonic energy.

The power control can be an analog waveform generator. In one embodiment, the system controller can be operably coupled to both the power control and the electrical signal generator. The electrical signal generator can be a variable frequency generator. In this embodiment, the electrical signal is preferably generated at a varying frequency. This results in the sonic energy being generated by the transducer to have a corresponding varying frequency.

In yet another aspect, the invention is a system for supplying power to a transducer for generating sonic energy comprising: a variable frequency generator for generating an electrical signal having a frequency; at least one transducer operably coupled to the variable frequency generator, the transducer adapted to receive and convert the electrical signal into corresponding sonic energy; and a system controller operably coupled to the variable frequency generator and adapted to vary the frequency of the electrical signal being generated, thereby resulting is the sonic energy being generated by the transducer to have corresponding varying frequency.

Preferably, this system will further comprise a power control operably coupled to an amplifier wherein the power control is adapted to convert the electrical signal received by the amplifier into an analog electrical signal having a peak amplitude. The power control can ramp the peak amplitude of the analog electrical leaving the amplifier. It is further preferred that the power control comprise an analog waveform generator.

In another aspect, the invention is a system for processing at least one substrate comprising: a process chamber having a support for supporting at least one substrate; means for applying sonic energy having a peak amplitude to a substrate positioned on the support, the means for applying sonic energy adapted to ramp the peak amplitude of the sonic energy during application of the sonic energy to a substrate; and a system controller adapted to control the means for applying sonic energy.

The means for applying sonic energy preferably comprises an electrical signal generator; an amplifier operably coupled to the electrical signal generator, the amplifier adapted to receive an electrical signal generated by the electrical signal generator; a power control operably coupled to the amplifier and the system controller, the power control adapted to convert the electrical signal received by the amplifier into an output electrical signal having a peak amplitude; at least one transducer operably coupled to the amplifier, the transducer adapted to receive the output electrical signal from the amplifier and convert the output electrical signal into the sonic energy; the peak amplitude of the sonic energy corresponding to the peak amplitude of the output electrical signal; and the power control further adapted to ramp the peak amplitude of the output electrical signal leaving the amplifier in response to control signals from the system controller. Preferably, the power control power control comprises an analog waveform generator.

When used during a start-up procedure, the power control will ramp the peak amplitude of the output electrical signal by gradually increasing the peak amplitude of the output electrical signal from a substantially zero value to a higher operating value in response to a start-up signal received from the system controller. When used to perform a sonic scrubbing action, the power control will preferably ramp the peak amplitude by repetitively increasing and decreasing the peak amplitude of the output electrical signal. As discussed above, this repetitive increasing and decreasing of the output electrical signal results in the peak amplitude of the sonic energy being correspondingly increased and decreased.

Optionally, the electrical signal generator will be a variable frequency generator. In this embodiment, it is preferred that the variable frequency generator be adapted to generate the electrical signal at a varying frequency, thereby resulting in the sonic energy being generated by the transducer to have a corresponding varying frequency.

In yet another aspect, the invention is system for processing at least one substrate comprising: a process chamber having a support for supporting at least one substrate; means for applying sonic energy at a frequency to a substrate positioned on the support, the means for applying sonic energy adapted to vary the frequency of the sonic energy during application of the sonic energy to a substrate; and a system controller adapted to control the means for applying sonic energy.

All necessary actions and/or adjustments of the systems of the invention can be automated through the use of a system controller. The system controller can be a suitable microprocessor based programmable logic controller, personal computer, or the like for process control and preferably includes various input/output ports used to provide connections to the various components of the inventive system(s) that need to be controlled and/or communicated with. The system controller also preferably comprises sufficient memory to store process recipes and other data. The specific type of system controller needed depends on the needs of the system (and its functioning) in which it is incorporated.

The method of the present invention is not limited to being carried out in any specific type of megasonic processing tool but can be incorporated into and/or carried out in rinse tanks, dryers, or any type of substrate process chamber which can perform single wafer and/or wafer batch processing. Moreover, the system of the present invention is not limited by the type of process tank/chamber being used and can be used in conjunction with single-wafer process chambers or batch-type process chambers. While in some embodiments, the system will comprise the process chamber having a support for supporting at least one substrate, the chamber can be a single wafer chamber or a batch immersion chamber. The support can support a plurality of wafers or one wafer, and in any orientation, including in a substantially horizontal orientation or in a substantially vertical orientation.

### BRIEF DESCRIPTION OF THE DRAWINGS

FIG. 1 is a schematic of a prior art megasonic power control system using analog amplitude control.

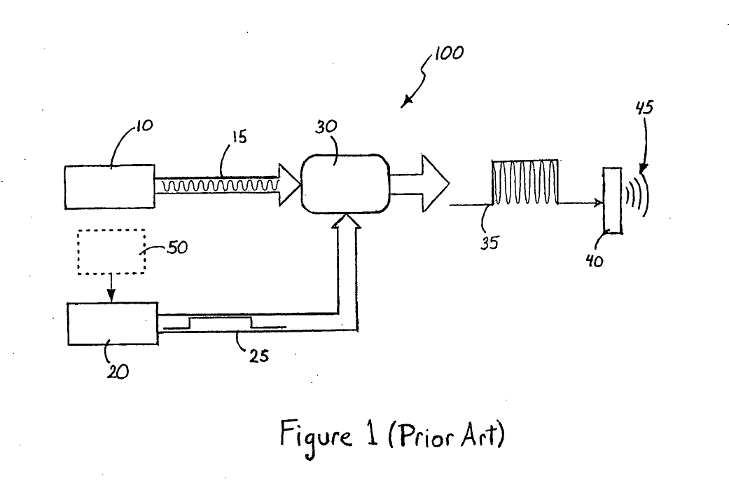

FIG. 2 is a schematic of a megasonic cleaning system incorporating a power control system according to a first embodiment of the present invention.

FIG. 3 is a schematic of a megasonic cleaning system incorporating a power control system according to a second embodiment of the present invention wherein the power control ramps the electrical signal through control of the amplifier.

FIG. 4 is a schematic of a megasonic cleaning system incorporating a power control system according to a third embodiment of the present invention wherein the power control ramps the electrical signal through control of the variable frequency generator.

FIG. 5 is a schematic of a megasonic cleaning system incorporating a power control system according to a fourth embodiment of the present invention wherein the power control ramps the electrical signal through control of the attenuator.

### DETAILED DESCRIPTION OF THE DRAWINGS

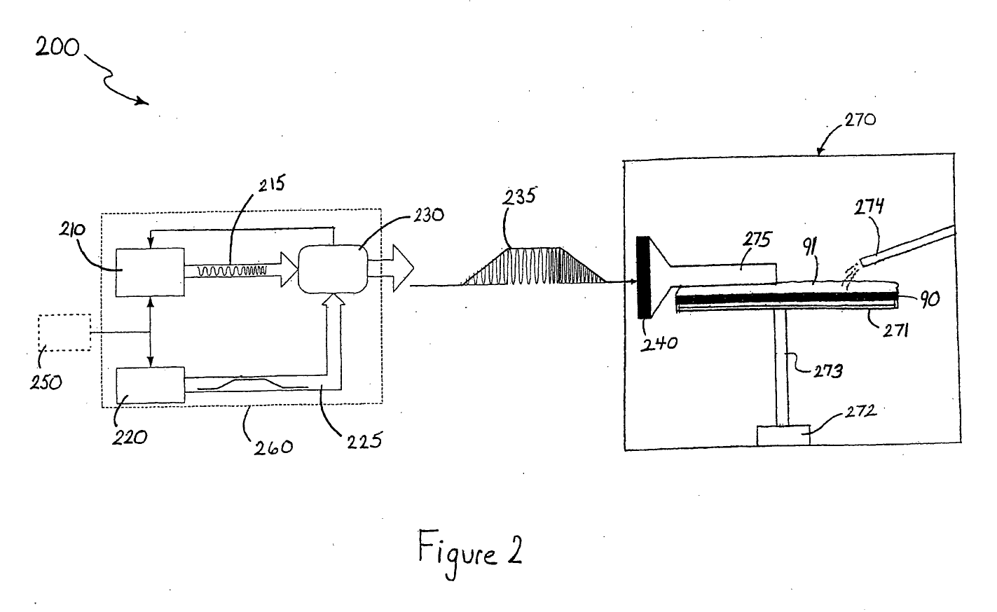

Referring to FIG. 2, a megasonic cleaning system 200 having amplitude ramping and frequency variance control according to an embodiment of the present invention is illustrated. The cleaning system 200 comprises a power control module 260 and a process chamber 270. The process chamber 270 is illustrated as a single wafer system. However, the invention is not so limited. Those skilled in the art will appreciate that the principles of the invention can also be applied to batch processing and/or immersion tank systems.

The process chamber 270 comprises a substrate support 271 for supporting a substrate 90 in a substantially horizontal orientation. The substrate support 271 engages the periphery of the substrate 90 so as to minimize the area of contact between the two. The substrate support 271 is coupled to a motor 272 via shaft 273. The substrate 90 can be rotated as desired during processing.

The process chamber 270 further comprises a nozzle 274 for supplying a film 91 of process fluid to the top surface of the substrate 90. The nozzle 274 is operably and fluidly coupled to a source, or sources, of process fluid (not shown). While aspects of the invention will be described in relation to a megasonic cleaning process wherein the nozzle 274 supplies a film 91 of cleaning fluid to the top surface of the substrate 90, the invention can be used to perform a wide variety of processing steps in which sonic energy is used, including without limitation, particulate removal, etching of dielectric films, photoresist stripping, drying, etc. The exact process fluid used will depend on the processing step being performed. As used herein the term fluid includes, without limitation, liquids, gases, liquid-liquid mixtures, liquid-gas solutions, and gas-gas mixtures.

The process chamber 270 further comprises an elongate probe transmitter 275 operably coupled to a transducer 240. The transmitter 275 is preferably constructed of a material that can effectively transmit sonic energy produced by the transducer 240. Suitable materials include, without limitation, quartz, boron nitride, and sapphire. However, other materials can be used, such as metals (including aluminum and stainless steel), polymers (including PVDF, Teflon, Halar, etc), and combinations of materials such as a Teflon Film over aluminum. While the transmitter 275 is exemplified as a generally cylindrical elongate probe, the transmitter can take on almost any shape, including, without limitation, a pie-shape, a plate, a lens, etc.

The transducer 240 can comprise one or more piezoelectric crystals having a primary operating frequency and one or more secondary operating frequencies, typically referred to as high-Q frequencies. The exact value of the primary operating frequency and the secondary operating frequencies of the transducer 240 will vary from transducer to transducer, and sre dictated by such factors as the quality of the piezoelectric crystal, the material of the piezoelectric crystal, the size and shape of the piezoelectric crystal, as well as the size and shape of the material used to transmit the sonic energy, and the properties of the process fluid.

The transducer 240 is electrically coupled to the power control module 260. The transducer 240 converts electrical signals received from the power control module 260 to sonic energy having characteristics that correspond to the characteristics of the electrical signal that drives the transducer 240. More specifically, the transducer 240 converts the electrical signal 235 outputted by the power control module 260 into sonic energy having an amplitude and frequency that corresponds to the amplitude and frequency of the electrical signal 235. The profile of the output electrical signal 235 over time is schematically illustrated along the electrical connection for ease of understanding.

The transmitter 275 is coupled to the transducer 240 in a manner such that when the transducer 240 converts the output electrical signal 235 into sonic energy, the sonic energy further is transmitted by the transmitter 275. When a film 91 of fluid is applied to the substrate 90, the transmitter 275 is in contact with the film 91. When the transducer 240 is activated, the sonic energy that is created is transmitted by the transmitter 275 through the film 91 of process fluid and to the substrate 90.

The power control module 260 comprises a variable frequency generator 210, a power control unit 220 having variable analog signal control capabilities, an amplifier 230, and a system controller 250. The power control module 260 affords active control of the amplitude and/or frequency of the sonic energy being generated by the transducer 240 by controlling the amplitude and/or frequency of the output electrical signal 235.

The system controller 250 is operably coupled to the variable frequency generator 210 and the power control unit 220 to afford control over the variable frequency generator 210 and the power control unit 220, and to afford communication therewith. The system controller 250 can be can be a suitable microprocessor based programmable logic controller, personal computer, or the like for process control and preferably includes various input/output ports used to provide connections to the various components of the inventive system(s) that need to be controlled and/or communicated with. The system controller 250 also preferably comprises sufficient memory to store process recipes and other data. The specific type of system controller needed depends on the needs of the system (and its functioning) in which it is incorporated.

As stated above, the power control module 260 controls the frequency and/or amplitude of the sonic energy generated by the transducer 240 by controlling the frequency and/or amplitude of the electrical signal 235 (i.e. power signal) outputted by the amplifier 230 and supplied to the transducer 240. In comparison to prior art systems, the power control system 260 provides an additional layer of control for the supply of the electrical signal 235 to the transducer 240. Specifically, the power control module 260 allows a user to control the amplitude and/or frequency of the electrical signal 235 delivered to the transducer 240 (and, in turn, the corresponding sonic energy generated and supplied to the substrate 90), instead of providing only analog level control of the power being supplied to the transducers, as is the case with prior art systems.

All of the hardware of the power control module 260 can be integrated into a single housing or box. The amplifier 230 can have a fixed software ramp built in and/or additional amplitude variations can be programmed thereafter. The amplifier 230 can be, for example, a class A or class AB amplifier, such as an AR Kalmus 75A250 amplifier. The amplifier 230 can also include a power monitor to determine both generated and reflected power to enable the system to adjust accordingly to maximize efficiency of power conversion.

The variable frequency generator 210 can be, for example, an HP3312A Arbitrary Waveform Generator or the like, such as an Agilient 33220A. The power control unit 220, for example, can be an analog waveform generator. The variable frequency generator 210 and the power control unit 220 are controlled via software from the system controller 250, which is preferably a host system computer, which is running a control algorithm that drives the optimum cleaning methodology for the product, chemistry, and process requirements.

The operation of the megasonic cleaning system 200 in performing a cleaning method according to one embodiment of the present invention will now be described. First, a substrate 90 is positioned in the process chamber 270 and supported on the support 271 in a substantially horizontal orientation. The operator selects a cleaning recipe from a user interface (not illustrated), thereby activating the system 200. Upon being activated, the system controller 250 retrieves the selected cleaning recipe from an internal memory and executes the commands stored therein.

The system controller 250 activates the proper pumps to supply a cleaning fluid, such as deionized water (“DI water”), ozonated DI water (“DIO3”), SC1, or SC2, to the top surface of the substrate 90 via nozzle 274. The substrate 90 is rotated through the activation of the motor 272 at a desired revolution-per-minute (“RPM”). The cleaning fluid forms a film/layer 91 atop the substrate 90. The film/layer 91 is in contact with the transmitter 275.

At the appropriate time in the cleaning recipe, the system controller 250 sends an activation command to the power control module 260. Upon receiving the activation signal, the variable frequency generator 210 generates and transmits a base electrical signal 215 to the amplifier 230. Depending on the specific processing needs, the base electrical signal 215 can either have a constant frequency or a varying frequency. The profile of the base electrical signal 215 is illustrated in FIG. 2. along the electrical connection for ease of understanding. As illustrated, the base signal 215 has an a frequency that is increasing over time and has a constant amplitude.

At the same time at which the variable frequency generator 210 is activated, the power control unit, is also activated by the system controller 250. In response, the power control unit 220 generates and transmits a variable analog control signal 225 to the amplifier 230. The profile of the variable analog control signal 225 is illustrated in FIG. 2. along the electrical connection for ease of understanding.

The amplifier 230 receives the base electrical signal 215 from the variable frequency generator 230 for conversion to the output electrical signal 235 (which will drive the transducer 240). Simultaneously, the power control unit 220 controls the amplitude of the output of the electrical signal 235 from the amplifier 230. The variable analog control signal 225. The power control unit 220 can either ramp-up and/or ramp-down the amplitude of the outputted electrical signal 235 through its coupling with the amplifier 230. All ramping of the amplitude of the outputted electrical signal 235 is preferably a non-step function. The ramping of the peak amplitude can take on, for example, a linear, parabolic, or S-profile. The invention, however, is not limited to any specific profile. The exact profile used in any situation will be determined by such factors as timing requirements, power levels, the type of process fluid used, etc.

During a start-up procedure, the power control unit 220 (via its control over the amplifier 230) ramps the amplitude of the output electrical signal 235 from a substantially zero value to an operating value. The exact operating value will be determined on a case- by-case processing basis, and will depend on such factors as the size and type of semiconductor devices on the substrate, cleanliness requirements, the size, style, and number of transmitters and/or transducers used, etc. The operating value of the peak amplitude of the electrical signal 235 will typically vary within a range of 1 Watt to 500 Watts. For example, The operating value of the peak amplitude may be within a range of 1 to 20 Watts when the process chamber is a single substrate chamber or within a range of 200 to 500 Watts when the process chamber being a batch process chamber. The invention, however, is not limited to a specific value.

The start-up ramping time is preferably within a time range of 0.0001 to 10 seconds, and more preferably within a time range of 0.001 to 1 second. The exact time will be determined on a case-by-case, considering such factors as the amplitude of the operating value, the type of transmitter used, process time restrictions, cleaning requirements, etc.

The profile of the start-up ramping of the peak amplitude of the output electrical signal 235 over time would look like the upwardly linearly ramped section of the signal profile illustrated in FIG. 2.

During the ramping procedure, the output electrical signal 235 is transmitted to the transducer 240 for conversion into sonic energy. Upon being received by the transducer 240, the electrical signal 235 is converted into sonic energy having frequency and amplitude characteristics that correspond to the frequency and amplitude characteristics of the output electrical signal 235. Thus, the ramping characteristics/profile of the output electrical signal 235 are also experienced by the sonic energy being created by the transducer 240. As discussed above, the sonic energy generated by the transducer 240 is transmitted to the substrate surface 90 via the transmitter 275 through the layer 91 of cleaning fluid.

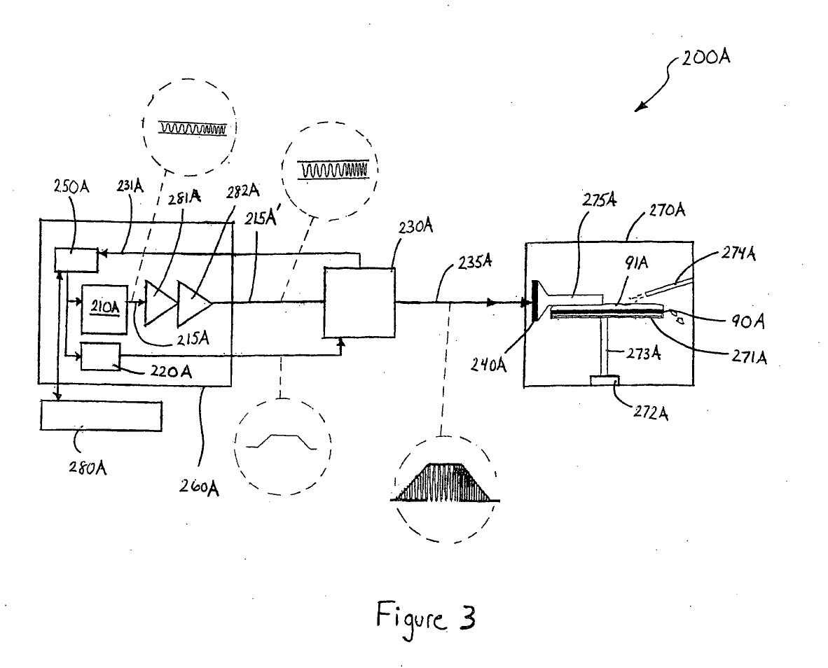

In accordance with the present invention, the peak amplitude of the output electrical signal 235 can be ramped by a variety of methods. The desired method for any system will be dictated by the hardware of that system. Such methods include: (1) controlling the amplitude output of the frequency generator itself (i.e., DDS chip); (2) providing an analog control signal to control the gain of a pre-amplifier for the electrical signal; (3) providing an analog signal to an attenuator, (wherein a pre-amplifier introduces a fixed gain before the attenuator); (4) providing an analog signal to an attenuator within the amplifier; and/or (5) providing an analog signal to the amplifier to adjust the amplifier gain. Some of these methods will be described below in view of the systems shown in FIGS. 3-5.

The megasonic power control module 260 can both vary the frequency and ramp the peak amplitude of the electrical signal 235 simultaneously if desired. In the alternative, megasonic power control module 260 can be operated so that only the frequency is varied or the peak amplitude is ramped, independent of the other. The exact requirements will be dictated by processing needs. The ramping of the peak amplitude and/or the varying of the frequency can be done once or repetitively during processing of a substrate 90. The capabilities of variably controlling the peak amplitude and modulating the frequency of the electrical signal 235 significantly improve the particle removal efficiency without causing damage to delicate devices on substrates subjected to the corresponding sonic energy 245.

Once the start-up ramping is completed, the power control system 260 can perform various other manipulations of the amplitude and/or frequency of the output electrical signal 235 in order to effectuate improved cleaning and/or decreased damage to the substrate. As will be explained in greater detail below, such manipulations include “sonic scrubbing,” “frequency sweeping,” and “frequency jumping.” These techniques can be implemented independent of the start-up ramping process, or in combination therewith. Furthermore, any of these techniques can either be used alone or in any combination with the other techniques. The performance of each of these techniques will be discussed below with respect to the megasonic cleaning system 200.

### Sonic Scrubbing

“Sonic scrubbing” is the action by which the power control system 260 repetitively increases and decreases the peak amplitude of the output electrical signal 235 in a cyclical manner within a predetermined range. The increases and decreases of the peak amplitude of the output electrical signal 235 are, of course, ramped in nature. The profile of the output electrical signal 235 shown in FIG. 2 is one embodiment of a single cycle of “sonic scrubbing” action. The logistics of ramping the output electrical signal 235 are the same as discussed above with respect to the start-up ramping procedure.

During a “sonic scrubbing” action, the peak amplitude of the output electrical signal 235 is preferably increased and decreased between an operating value and a percentage of the operating value. In one embodiment, the percentage can be being greater than or equal to about 10%.

Most preferably, the “sonic scrubbing” comprises repetitively increasing and decreasing the peak amplitude of the output electrical signal 235 in a cyclical manner between a de-minimus value and the operating value. By just avoiding total shut-off of the output electrical signal 235, undesirable effects, such as system instability, are avoided while allowing the amplitude to be ramped over the largest possible range possible. Driving small amounts of power into the piezoelectric crystal defines the impedance of the piezoelectric crystal the amplifier must drive, thus providing a stable system that can have faster ramping rates. The de-minimus value can be, for example, less than 1% of the operating value. The exact wattage of the de-minimus value will ultimately depend on the characteristics of the hardware used and the power needed to drive it.

By repetitively increasing and decreasing the peak amplitude of the output electrical signal 235, the peak amplitude of the sonic energy being subjected to the substrate 90 is also repetitively increased and decreased, thereby effectuating a sonic scrubbing action of the substrate surface. This repetitive increase and decrease of the peak amplitude can also be used in conjunction with other substrate processing steps, such as stripping.

### Frequency Sweeping

As mentioned above, the power control module 260 can adjust the frequency of the electrical signal 235 by controlling the frequency of the base electrical signal 215. In doing so, the system controller 250 adjusts the variable frequency generator 210 to accomplish the desired frequency variation of the base electrical signal 215. As shown in the profile of the base electrical signal 215 in FIG. 2, the frequency of the base electrical signal 215 is being increased over time. Changing the frequency of the base electrical signal 215 results in a corresponding change of the frequency of the output electrical signal 235, which in turn, results in a corresponding change in the sonic energy created by the transducer 240 and ultimately applied to the substrate 90.

During a “frequency sweeping” technique, the frequency of the output electrical signal 235 is repetitively increased and/or decreased within the predetermined range. In order to minimize energy loss and increase results, the predetermined range is preferably within +/−10% of a primary operating frequency of the piezoelectric crystal transducer 240. Most preferably, the predetermined range is within +/−1% of the primary operating frequency of the transducer. The invention, however, is not so limited and other bandwidths can be used. For example, the bandwidth surrounding one or more secondary operating frequencies of the piezoelectric crystal transducer can be used.

The predetermined range of the frequency sweep can be chosen to target the removal of certain sized particles from the substrate.

### Frequency Jumping

Another way in which the megasonic cleaning system 200 can utilize variations in frequency to improve substrate processing is through the technique of “frequency jumping.” In this technique, the power control module 260 quickly changes the frequency of the output electrical signal 235 from a primary operating frequency of the transducer 240 to at least one secondary operating frequency of the transducer, or vice versa.

It is preferred that all changes in the peak amplitude and/or frequency of the output electrical signal 235 are performed without interrupting the application of the sonic energy to the substrate 90. In other words, the start-up ramping, “sonic scrubbing,” “frequency jumping,” and/or “frequency sweeping” are performed without discontinuing the supply of the electrical signal 235 to the transducer 240. As a result, all changes are made on the fly during continuous megasonic processing of the substrate 90.

### Alternative Hardware/Control Embodiments

Referring now to FIG. 3, a megasonic cleaning system 200A incorporating a power control module 260A according to a second embodiment of the present invention is illustrated. The megasonic cleaning system 200A is similar to the megasonic cleaning system 200 of FIG. 2 with certain exceptions. As such, like numbers will be used to identify like elements, with the exception that the alphabetical suffix “A” will be added to the end of the numerical identifier. In order to avoid redundancy, only those important aspects of the megasonic cleaning system 200A that differ from the megasonic cleaning system 200 will be discussed in detail. The power control module 260A can perform any of the output signal 235A control techniques discussed above, including start-up ramping, “sonic scrubbing,” “frequency sweeping,” and/or “frequency jumping.”

Similar to the power control module 260 of FIG. 2, the power control module 260A of FIG. 3 controls the characteristics of its output electrical signal 235A through the power control unit 220A being operably coupled to the amplifier 230A. Importantly, the profiles of the various electric signals at each stage are shown in the dotted circles for ease of understanding.

The megasonic cleaning system 200A utilizes sonic energy to effectuate the cleaning of the substrate 90. However, the megasonic cleaning system 200A is also designed to reduce noise/impurities, such as signal distortion and spurious content, present in the output electrical signal 235A supplied to the sonic energy source, e.g., the transducer 240A.

The cleaning system 200A comprises process chamber 270A and a power control module 260A. The power control module 260 is coupled to a user interface 280A. The power control module 260A comprises a system controller 250A, a variable frequency generator 210A, a power control unit 220A, a pre-amplifier 281A, an attenuator 282A, and an amplifier 230A. All components are electrically and operably coupled as illustrated. The user interface 280A is operbaly coupled to the power control module 260A via the system controller 250A. The amplifier 230A is operbaly coupled to the attenuator 5A in order to receive the base electrical signal 215A.

The amplifier 230A is also coupled to the system controller 250A in order to transmit data representing forward/reflected power feedback, which is used in power control. The system controller 250A monitors the forward and reflected power measurements for feedback to control the power via line 231A. This feedback can also be supplied by an external Directional Coupler and/or independent voltage and current sensors. The system controller 250A will control the power level of the output electrical signal 235A to ensure that it does not exceed a target value in order to prevent potential damage to the substrate 90.

The power control module 260A is responsible for generating the base electrical signal 215A via the variable frequency generator 210A. During a substrate cleaning operation, a user activates the megasonic cleaning system 200A by inputting an activation command into the user interface 280A.

The variable frequency generator 210A can be a Direct Digital Synthesis Chip (DDS Chip). Other methods and hardware of frequency generation are also available, including an independent frequency generator.

Upon being created by the frequency generator 210A, the base electrical signal 215A is transmitted to the pre-amplifier 281A and the attenuator 282A where it is converted into intermediary electrical signal 215A′. The pre-amplifier 281A and the attenuator 282A provide some fine control over the amplitude of the base electrical signal 215A but do not ramp the amplitude or change the frequency.

The intermediary electrical signal 215A′ is then transmitted to the amplifier 230A where it is ramped as discussed above to create the output electrical signal 235A. The frequency of the output electrical signal 235A corresponds to the frequency (whether variable or steady) of the base electrical signal 215A, and can be varied through adjustment of the frequency generator 210A.

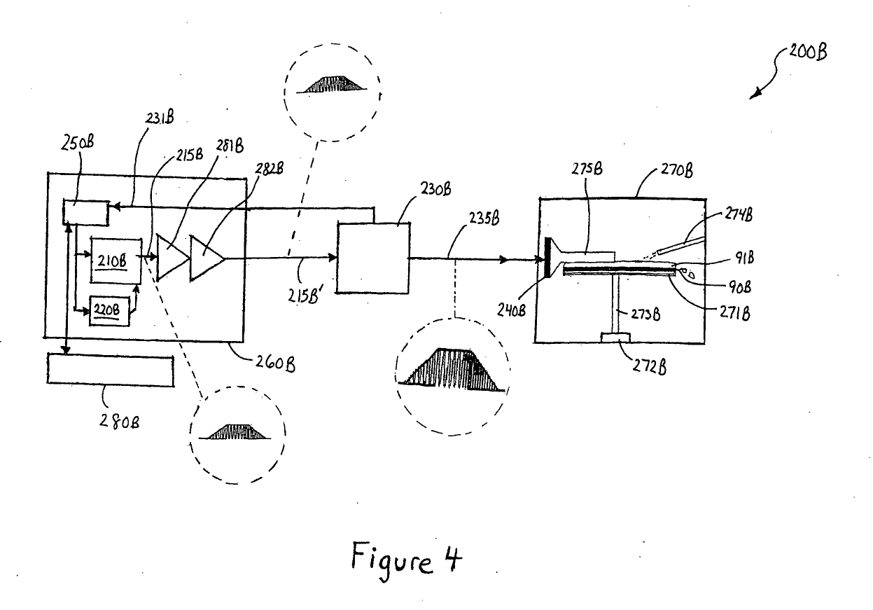

Referring now to FIG. 4, a megasonic cleaning system 200B incorporating a power control module 260B according to a third embodiment of the present invention is illustrated. The megasonic cleaning system 200B is identical to the megasonic cleaning system 200A of FIG. 3 with certain exceptions. As such, like numbers will be used to identify like elements, with the exception that the alphabetical suffix “B” will be used. In order to avoid redundancy, only those important aspects of the megasonic cleaning system 200B that differ from the megasonic cleaning system 200A will be discussed. The power control module 260B can perform any of the output signal 235B control techniques discussed above, including start-up ramping, “sonic scrubbing,” “frequency sweeping,” and/or “frequency jumping.”

Unlike the power control module 260A of FIG. 2, the power control module 260B of FIG. 4 controls the characteristics of its output electrical signal 235B through the power control unit 220B being operably coupled to the variable frequency generator 210B. More specifically, the power control unit 220B controls/ramps the amplitude of the output electrical signal 235B by controlling the amplitude characteristics of the base electrical signal 215 outputted by the frequency generator 210B itself (e.g., a DDS chip). The profiles of the signals at each stage are shown in the dotted circles for ease of understanding.

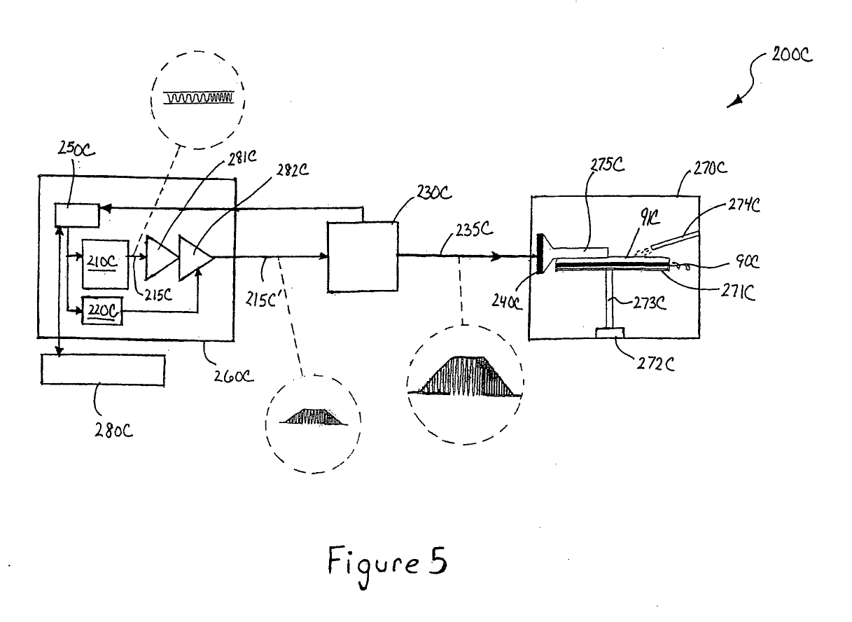

Referring now to FIG. 5, a megasonic cleaning system 200C incorporating a power control module 260C according to a third embodiment of the present invention is illustrated. The megasonic cleaning system 200C is identical to the megasonic cleaning system 200A of FIG. 3 with certain exceptions. As such, like numbers will be used to identify like elements, with the exception that the alphabetical suffix “C” will be used. In order to avoid redundancy, only those important aspects of the megasonic cleaning system 200C that differ from the megasonic cleaning system 200A will be discussed. The power control module 260C can perform any of the output electrical signal 235C control techniques discussed above, including start-up ramping, “sonic scrubbing,” “frequency sweeping,” and/or “frequency jumping.”

Unlike the power control module 260A of FIG. 2, the power control system 260C of FIG. 5 controls the characteristics of its output electrical signal 235C through the power control unit 220C being operably coupled to the attenuator 282C. More specifically, the power control unit 220C controls/ramps the amplitude of the output electrical signal 235C by providing an analog signal to the attenuator 282C. The profiles of the signals at each stage are shown in the dotted circles for ease of understanding.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a reading of the claims that follow.

Specifically, without limitation, the process chamber can be any type of chamber, including a single-wafer non-immersion style process chamber or a batch-type immersion process tank/chamber. Substrate processing requirements will dictate the exact type of process chamber, processing fluids/chemistries, and transducer assembly used. During operation, the substrate(s) can be supported in any orientation, including horizontally or vertically. Moreover, the substrate may be rotating or static. The transducer assembly can take the form of any shape, including a plate-like assembly, a lens-shaped assembly, or a pie-shaped assembly.

What is claimed is:

1. A method of processing a substrate with sonic energy comprising:
a) supporting at least one substrate in a process chamber;
b) generating a base electrical signal;
c) transmitting the base electrical signal to an amplifier, the amplifier converting the base electrical signal into an output electrical signal having a peak amplitude;
d) transmitting the output electrical signal to a transducer, the transducer converting the output electrical signal into corresponding sonic energy;
e) applying the sonic energy to the at least on substrate supported in the process chamber; and
f) ramping the peak amplitude of the output electrical signal.

2. The method of claim 1 wherein step f) comprises increasing the peak amplitude of the output electrical signal from a substantially zero value to an operating value during a start-up procedure.

3. The method of claim 2 wherein step f) is performed within a time range of 0.0001 to 10 seconds.

4. The method of claim 3 wherein step f) is performed within a time range of 0.001 to I second.

5. The method of claim 3 wherein the operating value of the peak amplitude is within a range of 1 to 20 Watts, the process chamber being a single substrate chamber.

6. The method of claim 3 wherein the operating value of the peak amplitude is within a range of 200 to 500 Watts, the process chamber being a batch process chamber.

7. The method of claim 1 wherein the ramping of step f) is performed by transmitting a ramped base electrical signal to the amplifier during step c).

8. The method of claim 1 wherein the ramping of step f) is performed during the conversion process of step c) by the amplifier.

9. The method of claim 1 wherein the ramping of the peak amplitude in step f) is not a step function.

10. The method of claim 9 wherein the ramping of the peak amplitude in step f) is a linear, parabolic, or S-profile function.

11. The method of claim 1 wherein step f) comprises repetitively increasing and decreasing the peak amplitude of the output electrical signal in a cyclical manner within a predetermined range.

12. The method of claim 11 wherein the predetermined range is between an operating value and a percentage of the operating value, the percentage being greater than or equal to about 10%.

13. The method of claim 1 wherein step f) comprises repetitively increasing and decreasing the peak amplitude of the output electrical signal in a cyclical manner between a de-minimus value and an operating value.

14. The method of claim 1 wherein the output electrical signal has a frequency, the method further comprising varying the frequency of the output electrical signal during the application of the sonic energy to the substrate.

15. The method of claim 14 wherein the frequency of the output electrical signal is changed from a primary operating frequency of the transducer to at least one secondary operating frequency of the transducer.

16. The method of claim 14 wherein the step of varying frequency of the output electrical signal is accomplished by varying frequency of the base electrical signal during generation.

17. The method of claim 14 wherein the frequency of the output electrical signal is varied within a predetermined range targeted to assist in removal of various sized particles from the substrate.

18. The method of claim 14 wherein the varying step comprises repetitively increasing and/or decreasing the frequency of the output electrical signal within the predetermined range.

19. The method of claim 18 wherein the predetermined range is within +/−10% of a primary operating frequency of the transducer, the transducer comprising a piezoelectric crystal.

20. The method of claim 18 wherein the predetermined range is within +/−1% of a primary operating frequency of the transducer, the transducer comprising a piezoelectric crystal.

21. The method of claim 1 wherein the converting of step c) is performed by an analog waveform generator operably coupled to the amplifier.

22. The method of claim 1 further comprising:
applying a film of cleaning fluid to a surface of the substrate supported in the process chamber, the substrate supported in a substantially horizontal orientation;
wherein the transducer is operably coupled to a transmitter, the transmitter coupled to the film of cleaning fluid;
wherein step e) comprises the transmitter transmitting the sonic energy through the film of cleaning fluid and to the surface of the substrate.

23. The method of claim 1 further comprising:
applying a film of cleaning fluid to a surface of the substrate supported in the process chamber, the substrate supported in a substantially horizontal orientation;
varying the frequency of the output electrical signal during the application of the sonic energy to the substrate;
wherein the transducer is operably coupled to a transmitter, the transmitter coupled to the film of cleaning fluid;
wherein step e) comprises the transmitter transmitting the sonic energy through the film of cleaning fluid and to the surface of the substrate;
wherein step f) comprises increasing the peak amplitude of the output electrical signal from a substantially zero value to an operating value during a start-up procedure;
wherein step f) is performed within a time range of 0.001 to I second;
wherein the operating value of the peak amplitude is within a range of 1 to 20 Watts;
wherein the ramping of the peak amplitude in step f) is a linear function; and
wherein the frequency of the output electrical signal is varied within a predetermined range targeted to assist in removal of various sized particles from the substrate.

24. A method of supplying power to a sonic energy source comprising:
a) generating a base electrical signal;
b) transmitting the base electrical signal to an amplifier;
c) the amplifier converting the base electrical signal into an output electrical signal having a peak amplitude;
d) transmitting the output electrical signal to a sonic energy source;
e) the sonic energy source converting the output electrical signal into corresponding sonic energy; and
f) ramping the peak amplitude of the output electrical signal.

25. A method of processing a substrate with sonic energy comprising:
a) supporting at least on substrate within a process chamber;
b) generating an electrical signal having a frequency;
c) transmitting the electrical signal to a sonic energy source;
d) the sonic energy source converting the electrical signal to sonic energy having a frequency corresponding to the frequency of the electrical signal;
e) applying the sonic energy to a surface of the substrate; and
f) varying the frequency of the electrical signal while the electrical signal, thereby correspondingly varying the frequency of the sonic energy being applied to the substrate.

26. The method of claim 25 further comprising:
applying a film of cleaning liquid to the surface of the substrate; and
wherein the frequency of the electrical signal is varied within a predetermined range targeted to assist in removal of various sized particles from the substrate.

27. The method of claim 25 wherein step f) comprises repetitively increasing and/or decreasing the frequency of the output electrical signal within a predetermined range.

28. The method of claim 27 wherein the predetermined range is within +/−10% of a primary operating frequency of the sonic energy source, the sonic energy source comprising a piezoelectric crystal.

29. The method of claim 28 wherein the predetermined range is within +/−1% of a primary operating frequency of the sonic energy source, the sonic energy source comprising a piezoelectric crystal.

30. The method of claim 25 wherein the sonic energy source comprises a piezoelectric crystal having a primary operating frequency and at least one secondary operating frequency, step f) comprising jumping the frequency of the electrical signal from the primary operating frequency of the piezoelectric crystal to one of the secondary operating frequencies of the piezoelectric crystal or vice versa.

31. A system for supplying power to a transducer for generating sonic energy comprising:
an electrical signal generator;
an amplifier operably coupled to the electrical signal generator, the amplifier adapted to receive an electrical signal generated by the electrical signal generator and convert the electrical signal into an output electrical signal having a peak amplitude;
a power control operably coupled to the amplifier, the power control adapted to ramp the peak amplitude of the output electrical signal; and
at least one transducer operably coupled to the amplifier, the transducer adapted to receive the output electrical signal from the amplifier and convert the output electrical signal to corresponding sonic energy.

32. A system for processing at least one substrate comprising:
a process chamber having a support for supporting at least one substrate;
means for generating sonic energy having a peak amplitude to a substrate positioned on the support;
means for ramping the peak amplitude of the sonic energy created by the generation means; and
a system controller adapted to control the means for applying sonic energy.

33. The system of claim 32 wherein the means for applying sonic energy comprises an electrical signal generator; an amplifier operably coupled to the electrical signal generator, the amplifier adapted to receive an electrical signal generated by the electrical signal generator; a power control operably coupled to the amplifier and the system controller, the power control adapted to convert the electrical signal received by the amplifier into an output electrical signal having a peak amplitude; at least one transducer operably coupled to the amplifier, the transducer adapted to receive the output electrical signal from the amplifier and convert the output electrical signal into the sonic energy; the peak amplitude of the sonic energy corresponding to the peak amplitude of the output electrical signal; and the power control further adapted to ramp the peak amplitude of the output electrical signal leaving the amplifier in response to control signals from the system controller.
